(19) United States
(12) Patent Application Publication
(10) Pub. No.: US 2013/0199809 A1
(43) Pub. Date: Aug. 8, 2013

(54) ASSEMBLY DEVICE AND ASSEMBLY METHOD

(71) Applicant: Thomas Zeller, Aalen (DE)

(72) Inventor: Thomas Zeller, Aalen (DE)

(73) Assignee: ALFING MONTAGETECHNIK GMBH, Aalen (DE)

(21) Appl. No.: 13/638,790

(22) PCT Filed: Mar. 31, 2010
(86) PCT No.: PCT/EP10/54367

§ 371 Date: Mar. 18, 2013

(51) Int. Cl. B25B 23/147

(52) U.S. Cl. CPC B25B 23/147
USPC 173/1; 173/176

(57) ABSTRACT

The invention relates to an assembly device (100) and method having a screw device (101) for tightening and loosening screws, having a screw head (102) and a housing (103), wherein measurement errors of an angle measuring device (104) are corrected by means of a detecting unit (105) for detecting erroneous sensor data in the rest state, and more precise and secure tightening of screws of nuts is thereby enabled.

### TECHNICAL DOMAIN

The present invention relates to an assembly device and method having a motor-driven screw device for tightening or releasing screws.

### BACKGROUND TO THE INVENTION

In many areas of technology, such as in automobile manufacture, screw connections are used for the connection of components. In this situation, rotation angle or yield point tightening methods are used for the tightening of the screws. By contrast with torque tightening methods, with which a screw connection is tightened until a specific moment value is attained, these tightening methods offer a greater degree of precision with regard to the pretension force attained in the screw connection, and a better exploitation of the strength of the screw. As a result, the loading imposed on the screw in the case of dynamic screw connections is reduced, which in the case of screw connections with changing loading at the screw is of great significance with regard to the durability of the screw connection.

With rotation angle-controlled tightening methods, the screw is further tightened by a predefined angle from a joint or threshold moment value. In this situation, the maintaining of the rotation angle is of extreme importance, since this directly influences the strength and durability of the connection. With the yield point-controlled tightening method, the acquisition of the real rotation angle, about which the screw rotates during tightening, is determinant for the result of the tightening.

If the tightening of the screw is carried out with a hand-held motor-driven screwing tool, a rotation of the screwing tool about the axis of the screw head by the user of the screwing tool can influence directly the rotation angle by which the screw is rotated further from the joint or threshold moment value. This leads to the situation that the measured rotation of the screw head in relation to the housing of the screw device does not concur with a rotation angle of the screw head in relation to the workpiece. Accordingly, with a hand-held screwing tool, the rotation angle cannot be correctly determined, because it may be influenced by movement of the screw tool.

Accordingly, the use of hand-held motor-driven screw tools is not to be considered in cases of safety-relevant screw connections, since the maintaining of the rotation angle after the attaining of the joint or threshold moment value cannot be ensured. This applies in particular to screw connections classified in accordance with VDI 2862 A, which are classified as screw connections with risk to life and limb, as well as for B-classified screw connections which could result in the failure of relevant functions or breakdown of a motor vehicle.

### PRIOR ART

Hitherto, for the reasons given above, screw devices are mainly used which are supported against the workpiece or mounted in a fixed manner. In this situation, a rotation of the screw device in relation to the workpiece is not possible.

A disadvantage with this device is that it is substantially less flexible than hand-held screw devices, since the screw device must be supported in every case against the workpiece. This accordingly renders flexible and time-saving use impossible. Support against the workpiece is in most cases also not attainable. The alternative of a screw device fitted securely to a handling device (stand, telescope) likewise restricts flexibility.

To monitor the movement of the housing of the screw device relative to the surroundings, Patent Specifications DE 4 243 317 A1 and DE 4 343 110 C2 in each case propose angle measuring devices for the acquisition of the rotation angle of the housing about the axis of the screw head relative to the surroundings.

The intention is for the movement of the screw device relative to the surroundings to be determined more precisely, and therefore the rotation angle of the screw head relative to the workpiece, by the correction of the acquired rotation angle of the screw head in relation to the housing, by the acquired rotation angle of the housing about the axis of the screw head relative to the surroundings.

A disadvantage with these embodiments is that the operational reliability and safety of the methods and devices is not ensured. Accordingly, a measurement error of the sensors which can occur, for example, due to temperature fluctuations or defects in the sensors, cannot be determined. A reliable determination of the rotation angle of the screw relative to the workpiece is therefore also not possible with these systems. Moreover, VDI 2862 requires for A-classified screw connections a redundant monitoring of the measurement and control values, as well as a self-test of the measurement sensory devices. Because the rotation angle belongs to these measurement and control values, method and device in accordance with the description in the Patents referred to are not practically applicable. For B-classified screw connections, too, their use is not advisable, since erroneous tightening, for example in automobile manufacture, can cause serious material damage.

### OBJECT OF THE INVENTION

It is therefore desirable to provide an improved screw device and method which solve at least some of the problems referred to, and lead to a more precise, more reliable, and safer tightening of screws and nuts.

### Solution of the Object

A solution of this object is provided by the assembly device with the features of claim 1.

This assembly device comprises a motor-driven screw device for the tightening or releasing of screws, with a screw head and a housing, wherein the screw device comprises a first angle measuring device for the determination of the rotation angle of the housing about the axis of the screw head relative to the surroundings. The assembly device is characterized in that it comprises a detection unit for the recognition of the rest state and comparison means for comparing the sensor values measured at the rest state with predefined threshold values.

Accordingly, the rotation angle of the housing about the axis of the screw head relative to the surroundings is determined by the first angle measuring device. By means of the detection unit for the recognition of errored sensor data, it is now determined by the means for recognizing the rest state whether the screw device is in a rest state. If this is the case, then the sensor values measured in the rest state of the first angle measuring device are compared with predefined threshold values.

Since the values to be measured of the first angle measuring device in the rest state are known, the measured angle should essentially be zero, and it is now possible, by comparison with a predefined threshold value or a tolerance range respectively to determine whether the outputs from the first angle measuring device are correct. If the first angle measuring device measures a value in the rest state which exceeds or falls short of the threshold value, then there is evidently an error in the angle measuring device. Further use of the screw device can then be suppressed in order to prevent screw connections from being tightened with a defective first angle measuring device, which can lead to defective screw connections. It is also possible for connections carried out since the last test by the test means to be assessed as not being in order, since a correct function of the first angle measuring device for these screw connections cannot be guaranteed.

In consequence, it is possible with an assembly device of this nature for erroneous sensor data from angle measuring devices in a screw device to be detected, and, as appropriate, for a signal to be issued to the user or for the assembly device to be blocked. This increases safety and reliability with the use of hand-held motor-driven screw devices, and allows for a self-test of the measurement sensor apparatus.

### Further Embodiments And Advantages Thereof

The detection unit is preferably arranged with a signalling means for sending a message to the user and a blocking means for suppressing the use of the screw device.

This makes it possible, in the event of erroneous function of the angle measuring device being detected, for the user to be informed of this erroneous function, and for further use of the screw device to be suppressed, in order to avoid use with incorrectly functioning angle measuring devices, and therefore possibly erroneous screwing.

The means for detecting the rest state in one embodiment comprises preferably at least one sensor in the screw device for the detection of movement.

With the sensor for the detection of movement, a movement of the screw device can be detected, since the sensor is positioned in the screw device. If the output value does not change over a time unit, which may be relatively short, or within narrow limits, then it can be assumed that the tool is in a rest state, and a detection of erroneous sensor data can be carried out.

In another embodiment, the means for detection of the rest state can comprise a sensor, in the screw device, for detecting the contact of the screw device with a surface, or its coming close to a surface.

This allows for the detection of the rest state on the basis of the detection of the tool lying on a surface or approaching this surface. Such a detection can be acquired, for example, by means of a pressure sensor or other sensor on an inductive, capacitive, optical, or mechanical basis. This type of detection of the rest state is very robust, since, for example, mechanical sensors for the detection of physical contact have a very low error probability.

In a further embodiment, the means for detecting the rest state can comprise a tool stand with at least one sensor for detecting the placement of the screw device in the tool stand for the detection of the rest state.

In a similar manner to the foregoing embodiment, a reliable detection of the rest state can also be achieved in this case. At the same time, simple integration into the previous operating sequence is possible, since the tool is often deposited in a tool stand between the screwing procedures.

According to a further embodiment, the means for detection of the rest state can comprise means, in the screw device, for detecting the position of the screw device in space, such as triangulation.

This allows for a detection of the rest state even without its being deposited in a specific tool stand. This accordingly means that even holding the tool very gently, or laying it down on any other desired surface can therefore be detected as a rest state. This increases the flexibility of the use of the screw device.

According to a further embodiment, the means for detection of the rest state can comprise at least one transponder and a means for reading the transponder, wherein either the transponder or the means for reading the transponder are arranged in the screw device.

The comparison means can also be designed in such a way that they compare the sensor values with a minimum limit value and a maximum limit value.

The comparison means can also be designed in such a way that they compare the sensor data with a tolerance range around a defined initial value.

In a further embodiment, the assembly device further comprises means for time measurement, which measure the time since the last detected situation of the screw device being laid down, detected by the means for the detection of the rest state, signalling means for signalling a message to the user if the measured time exceeds a first threshold value, and blocking means for suppressing the use of the screw device if the measured time exceeds a second threshold value.

This ensures that the screw device is regularly laid down, and that measurement errors can be regularly determined. Erroneous screw operations can therefore further be minimized, since errors in the sensors which may occur, for example, due to defects or heating of the screw device due to long use, can be identified in good time. In this situation, the user is first requested to lay the screw device down. Should he fail to follow this request, the use of the screw device will be suppressed if a second threshold value is exceeded.

In a further embodiment, the assembly device comprises a second angle measuring device for the detection of the rotation angle of the screw head relative to the housing, provided in the screw device, and an angle correction unit for the determination of the actual rotation angle of the screw head relative to the surroundings from the measured rotation angle of the screw head and the detected movement of the housing, provided in the assembly device.

Due to the additional second angle measuring device, in addition to the rotation angle of the housing about the axis of the screw head relative to the surroundings, the rotation angle of the screw head relative to the housing is also measured, which allows for a determination of the actual rotation angle of the screw head relative to the surroundings by the angle correction unit.

In a further embodiment, the first angle measuring device comprises several sensors for the redundant measurement in each case of the rotation angle of the screw device, or at least of an intrinsically secure sensor. The first angle measuring device can also comprise several sensors with different measuring methods, such as rotation rate sensors or acceleration sensors.

In particular, an assembly device can be equipped with error detection means for the detection of measurement errors from the sensors, wherein the error detection means comprise calculation means for the calculation of at least one difference value of the several measured values of the several sensors, signalling means for sending a message to the user if at least one difference values exceeds a threshold value, and blocking means for suppressing the use of the screw device.

By the use of several sensors or of an intrinsically safe sensor, wherein the several sensors can exhibit different measuring methods, and, by the use of error detection means, erroneous sensor data can be detected during operation and a corresponding assessment of the screw connection made, signalling to the user or blocking of the screw device can be put into effect. This supports the detection of erroneous sensor data and the ensuring of error-free screwing.

Further embodiments can also comprise measurement range comparison means for the comparison of measured sensor values of the first angle measuring device with a predetermined measurement range of the sensors of the first angle measuring device, supply voltage measuring means for monitoring the supply voltage of the sensors, or at least one temperature measuring unit located in the area of at least one sensor, for measuring the temperature of the at least one sensor.

In a preferred embodiment, the screw device can be designed as an electrical, hydraulic, or pressure-driven screw device. The screw device may also comprise a battery for the power supply.

The object is also solved by a method according to claim 20.

The method for tightening or releasing screws by means of a motor-driven screw device with a screw head and a housing comprises the step of detection of a rotation angle of the housing about the axis of the screw head relative to the surroundings by means of a first angle measuring device, and is characterized by the step of the detection of erroneous sensor data in the rest state by means of a detection unit, which comprises the steps of detection (S1803) of the rest state and the comparison of the sensor values measured in the rest state with predefined threshold values by comparison means.

Advantageously, the method further comprises the steps of sending a message to the user by a signalling means and the suspension of the use of the screw device by blocking means.

Advantageously, the step of detection of the rest state comprises the detection of movement by means of a sensor in the screw device.

Advantageously, the step of detection of the rest state comprises the detection of a constant output value of a sensor or of the angle measuring device respectively, over a predetermined period of time.

Advantageously, the step of detection of the rest state comprises the detection of a contact of the screw device with a surface, or its coming close to a surface.

Advantageously, the step of detection of the rest state comprises the detection of the laying of the screw device in a tool stand.

Advantageously, the step of detection of the rest state comprises the position determination of the screw device in space, for example by way of triangulation.

Advantageously, the method further comprises the steps of measuring the time from the last detected depositing of the screw device, of the signalling of a message to the user, if the measured time exceeds a first threshold value, and the suspension of the use of the screw device if the measured time exceeds a second threshold value.

Advantageously, the method also comprises the steps of detection of the rotation angle of the screw head relative to the housing and the detection of the actual rotation angle of the screw head relative to the surroundings from the measured rotation angle of the screw head and the detected rotation angle of the housing.

Advantageously, the method further comprises the steps of calculation of at least one difference value from several measured values from several sensors of the first angle measuring device, the sending of a message to the user if at least one difference value exceeds a threshold value, and the suspension of the use of the screw device if at least one difference value exceeds the threshold value or another predetermined threshold value.

Advantageously, the method further comprises the steps of the determination of a rotation angle speed of the housing about the axis of the screw head, the comparison of the rotation angle speed with a threshold value, and the assessment of an ongoing screwing operation as not being in order if the rotation angle speed exceeds the threshold value.

Advantageously, the method further comprises the steps of the comparison of the rotation angle of the housing about the axis of the screw head with a threshold value and the assessment of an ongoing screwing operation as not in order if the rotation angle exceeds the threshold value.

Advantageously, the method further comprises the step of the assessment of an ongoing screwing operation as not in order if an error arises during the screwing operation.

Further advantageous embodiments and improvements of the invention are provided in the sub-claims. The invention is explained in greater detail hereinafter on the basis of its embodiments, making reference to the drawings.

### BRIEF DESCRIPTION OF THE DRAWINGS

The drawings show:

FIG. 1: The general principle of the assembly device according to the invention;

FIG. 2: An extended embodiment of the detection unit;

FIG. 3: An assembly device with a further embodiment of the means for the detection of the rest state;

FIG. 4A: Further embodiment of the means for detection of the rest state;

FIG. 5A: Further embodiment of the means for detection of the rest state with a tool rest;

FIG. 5bA: Further embodiment of the means for detection of the rest state;

FIG. 6A: Further embodiment of the means for detection of the rest state by means of triangulation;

FIG. 7A: Further embodiment of the comparison means;

FIG. 8A: Further embodiment of the comparison means;

FIG. 9A: Further embodiment of the assembly device with signalling and blocking means;

FIG. 10A: Further embodiment of the assembly device with an angle correction unit;

FIG. 11A: Further embodiment of the angle measuring device;

FIG. 12A: Further embodiment of the angle measuring device;

FIG. 13A: Further embodiment of the angle measuring device; and

FIG. 14A: Further embodiment of the assembly device with error identification means;

FIG. 15A: Further embodiment of the assembly device;

FIG. 16A: Further embodiment of the assembly device;

FIG. 17A: Further embodiment of the screw device;

FIG. 18 A: Flow diagram of an embodiment of the method according to the invention;

FIG. 19 A: Flow diagram of a further embodiment of the method according to the invention;

FIG. 20 A: Flow diagram of a further embodiment of the method according to the invention;

FIG. 21 A: Flow diagram of a further embodiment of the method according to the invention;

FIG. 22 A: Flow diagram of a further embodiment of the method according to the invention;

### BASIC PRINCIPLE OF THE INVENTION

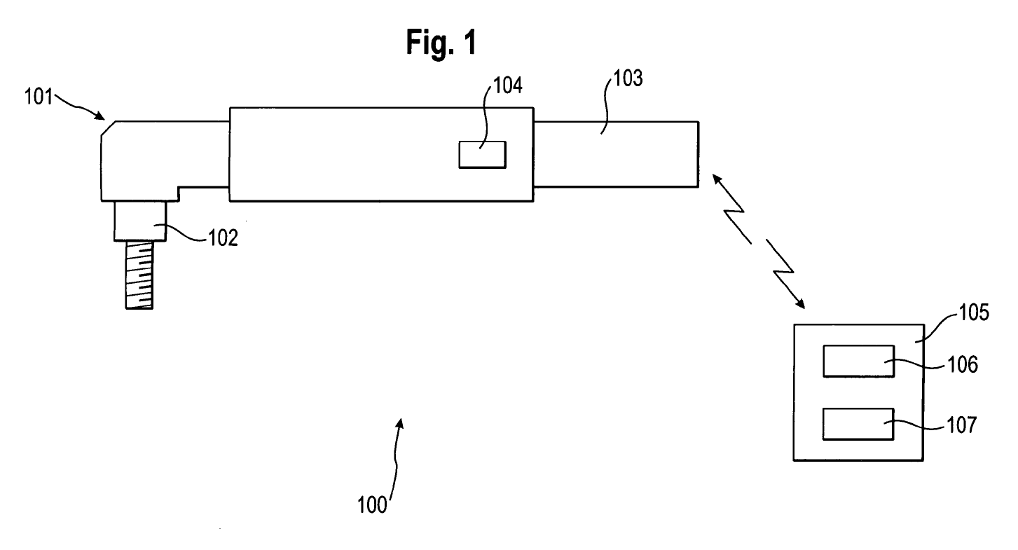

The basic principle of the invention is represented in FIG. 1. On the basis of this Figure, the basic principle of the invention will be explained in greater detail hereinafter.

An assembly device 100 comprises a motor-driven screw device 101 for tightening or releasing screws. The screw device 101 consists of a housing 103 and a screw head 102, which is designed to accommodate screws or nuts. Provided in the housing 103 of the screw device 101 is a first angle measuring device 104 for detecting a rotation angle of the housing about the axis of the screw head relative to the surroundings. The assembly device 100 further comprises a detection unit 105 for the detection of missing sensor data in the rest state, which comprises means 106 for the detection of the rest state and comparison means 107 for the comparison of the sensor data measured in the rest state with predefined threshold values. The detection unit can be arranged both externally outside the screw device 101 or inside the housing 103 of the screw device 101. If the detection unit 105 is arranged outside the screw device in the assembly device 100, then it is connected to the screw device, for example by means of a cable connection. Other means of data transfer are also conceivable, e.g. by wireless. The first angle measuring device 104 can be designed, for example, as a rotation speed sensor or as a combination of several acceleration sensors.

The object of the first angle measuring device 104 is now to check for possible erroneous measured values. To do this, a check is carried out by the means for detection of the rest state as to whether the screw device 101 is in the rest state. Possible methods for determining the rest state are described hereinafter. For example, the output of a rotation rate sensor can be drawn on to determine the rest state, in that a check is made as to whether the output of the sensor is essentially constantly zero. If, for example, the output of the sensor over a defined period of time is smaller than a defined threshold value, then it may be assumed that a rest state pertains. The comparison means 107 can then compare the output from the first angle measuring device with predefined threshold values. If the sensor values measured do not lie within the tolerance range determined by the predefined threshold values, then it is to be assumed that the first angle measuring device 104 is not functioning correctly. This may be caused, for example, by a defective angle measuring device, temperature fluctuations, or other influences. If appropriate, suitable measures can now be taken, such as notification to the user, blocking of the assembly device, or an appropriate assessment of the most recent screwing operations. More precise details are provided hereinafter.

Likewise, for example, a correction of the measured values from the first measuring device can be carried out, for example by the definition of a first zero point, provided that the sensor values lie within permissible limits.

Accordingly, a precise and reliable angle measurement by the first angle measuring device can be assured, and the detection of erroneous sensor data enabled.

### EMBODIMENTS OF THE INVENTION

Preferred embodiments of the present invention are described in detail hereinafter, by reference to the appended drawings. In this situation, components in different drawings which are the same or correspond to one another are designated in each case by the same or similar reference numbers.

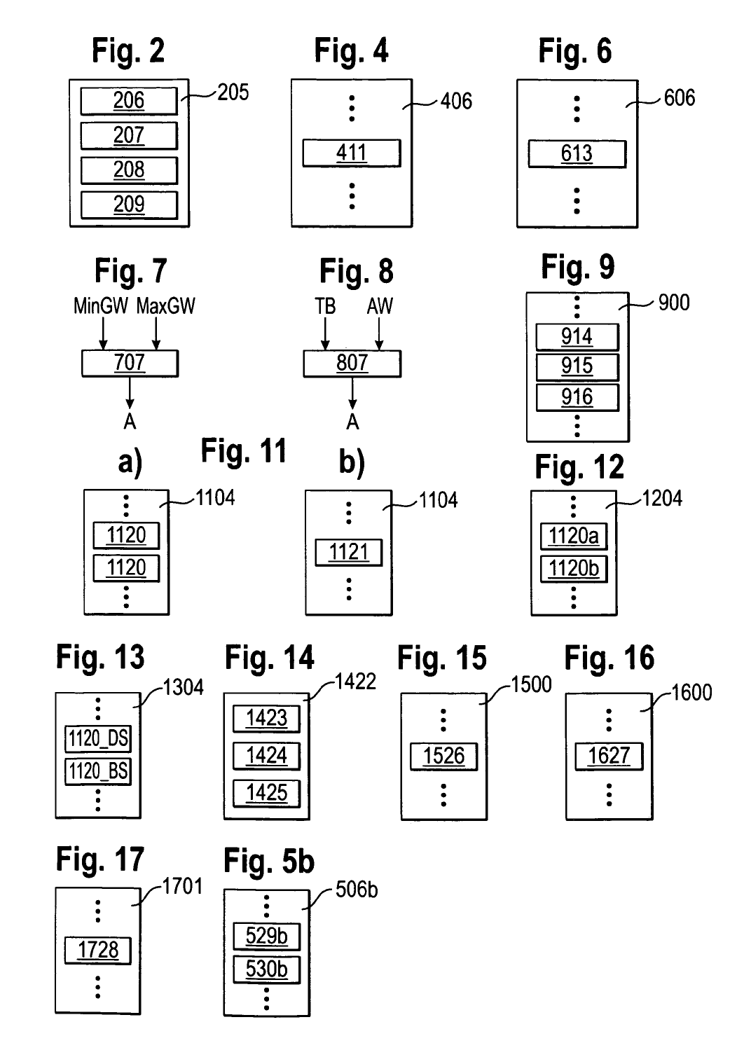

FIG. 2 shows a further embodiment of the detection unit according to the invention. In this situation, in addition to the means 206 for the detection of the rest state and the comparison means 207 for the comparison of the sensor values measured in the rest state with defined threshold values, signalling means 208 are provided for the sending of a message to the user, and blocking means 209 to suppress the use of the screw device. In the event of an exceeding/shortfall of the predefined threshold values being detected at the comparison means 207, then a message can be sent to the user by the signalling means 208. This can, for example, be of visual and/or audible type. A vibration alarm or a clear text display is also conceivable. A combination of different signalling methods is of course also conceivable. With the aid of the blocking means 209, it is possible, simultaneously or after a specific time after the notification to the user by the signalling means 208, for the suppression of the use of the screw device to be carried out. This can, for example, be carried out by an interruption of the voltage supply in the case of electrical screw devices or other supply means, such as compressed air in the case of screw devices driven by compressed air. Other means of blocking, such as blocking of a control element, such as a switch, for example, are also conceivable. Accordingly, further use of the screw device in the event of a defect will be avoided or suppressed.

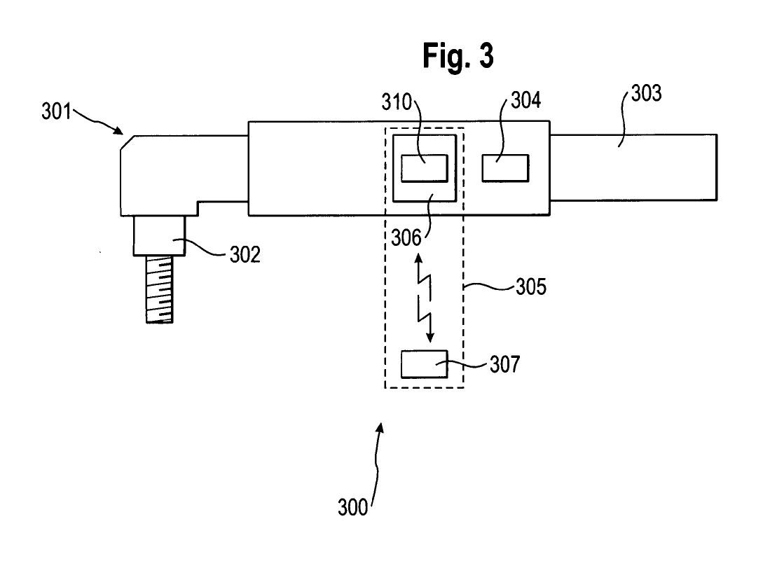

FIG. 3 represents an embodiment of the means 306 for the detection of the rest state. In this situation, at least one sensor 310, as part of the means 306 for the detection of the rest state, is located in the screw device 301, for preference in the housing 303. By analogy with the method described under “Basic principle of the invention”, it can be determined by means of the sensor 310 whether the screw device is in the rest state. The sensor 310 can in this situation be designed, for example, as an acceleration sensor. A design as an inclination or revolution rate sensor or other movement sensor is, however, likewise possible and conceivable. After the detection of the rest state, a check and/or correction of the measured values from the first angle measuring device can then be carried out. The comparison means 307 of the detection unit 305 can in this situation be arranged on the outside, i.e. also inside the screw device 301.

FIG. 4 shows a further possibility for the design of the means 406 for the detection of the rest state. In this situation, a sensor 411 is provided in the screw device, which detects the contact of the screw device 101 with a surface. In this situation, the sensor can be, for example, a pressure sensor or another type of inductive, capacitive, optical, or mechanical sensor/switch. In this situation, no direct contact between the screw device and the surface is necessary, such that use may be made, for example, of proximity switches or reflection light barriers, with which a certain interval may pertain between the screw device and the surface. Likewise, several corresponding switches can be arranged in the screw device 101, such that laying down can be detected on each side of the screw device.

The detection of laying down by means of a sensor in this situation represents a relatively reliable detection of the rest state, since few sensors can be used, which are less prone to defect and are technically simple. A combination of several different sensors for the detection of the device being laid down is also conceivable.

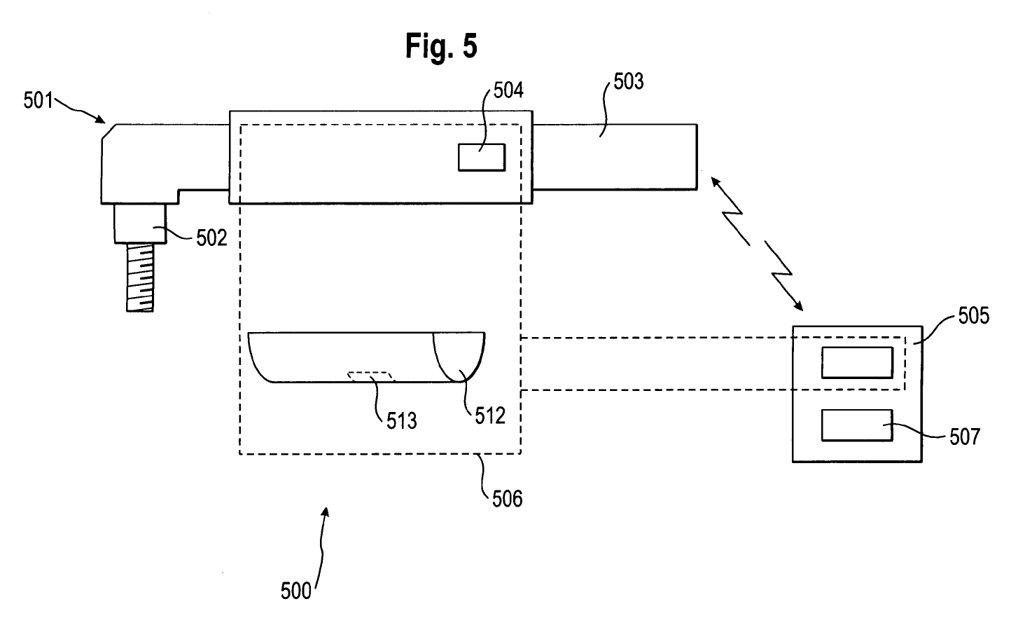

In FIG. 5, the means 506 for the detection of the rest state comprises a tool stand 512. Provided in this tool stand is a sensor 513 for the detection of the screw device 501 being laid in the tool stand 512. This sensor can function in a similar manner to the foregoing embodiment, on an inductive, capacitive, optical, or mechanical basis. The tool stand 512 can, for example, be secured as a fixture at the place of use of the screw device 501. If the screw device 501 is deposited in the tool mount 512, this will be detected by the sensor 513. The screw device 501 is now is the rest state, and the detection and, if appropriate, correction of measurement errors of the first angle measuring device can be carried out. The tool mount 512 can be designed in different forms and can also be designed in such a way that the screw device 501 can be laid down in any desired orientation and position on the tool mount 512, including in such a way that the screw device 501 can only be laid down in a fixed predetermined orientation and position. The latter arrangement further offers the possibility that, for example, acceleration sensors used in the screw device 501 can be checked not only for constant values but, because the position of the sensors in the screw device 501 is known, and therefore also the position of the sensors in relation to the tool mount 512, the correctness of the measured values can also be checked. The tool mount 512 can also be equipped with further elements, such as a charging station for battery-powered screw devices, or other additional components.

FIG. 5b shows a further embodiment of the means 2206 for the detection of the rest state, wherein the assembly device comprises at least one transponder 529b and a means 530b for reading the transponder, wherein either the transponder or the means for reading the transponder are arranged in the screw device.

By means of a cyclic check as to whether the means for reading the transponder, which can, for example, be arranged in a mount, can in fact read out the transponder, which can, for example, be arranged in the screw device, the rest state can be detected. If reading is possible, then it is to be assumed that the screw device, in this example, is in the mount. A rest state can therefore be detected. Naturally, in this situation means for reading the transponder can also be arranged in the screw device, wherein the transponder must then be arranged outside the screw device.

Other combinations of transmitters and receivers can naturally also be used.

FIG. 6 shows a further embodiment of the means 606 for detection of the rest state, wherein the screw device 606 comprises means 613 for the position determination of the screw device in space, for example by triangulation. With the aid of the means 613, the position of the screw device in space can be determined. If the position is essentially constant over a specified period of time, it can be assumed that the screw device 606 is in a rest state, and detection and correction of measured sensor values can be carried out. A position in space, such as, for example, the position of a tool mount, can also be defined as a rest position, at which the screw device must be laid down in a cyclic manner. In this situation, triangulation is only an example of a position determination of the screw device 606 in space. Further possibilities for position determination are generally known to the person skilled in the art.

Every one of the foregoing possible embodiments of the means for the detection of the rest state can be combined with one or more other embodiments at will, in order to allow for a more precise and/or redundant detection of the rest state. Thus, for example, the combination of a tool mount 512 with a sensor 310 in the screw device is conceivable.

FIGS. 7 and 8 represent possible embodiments of the comparison means 707, 807. In this situation, the sensor values can be compared either with a minimum limit value MinGW and a maximum limit value MaxGW, or with a tolerance range around a defined initial value AW. In the latter case it is conceivable, for example, when the assembly device 100 is taken into operation, for a measured value of the first angle measuring device to be determined as zero. This will allow for an offset which may be contained to be compensated for. A tolerance range can then be defined around this initial value, in which the sensor values in the rest state can be assumed to be correct. A combination of absolute minimum limit values MinGW and maximum limit values MaxGW with relative limit values related to an initial value AW is conceivable. If the absolute limit values in the rest state are defined, for example, as −200 and +200 and, additionally, a maximum fluctuation around the initial value of +/−50 is permitted, then, with an initial value AW of 160, by way of example, the signal in the rest state may fluctuate between +110 and +200. If this range is exceeded or undercut, this will be defined as an erroneous function of the angle measuring unit and corresponding measures will be initiated as described heretofore.

A new definition of the zero point or of the initial value AW respectively with a detection of a correct signal in the rest state is also conceivable. This would allow for a correction of the outputs from the first angle measuring device even in the event, for example, of constant changes due to temperature changes in operation.

FIG. 9 shows an assembly device 900, which further comprises means 914 for time measurement, signalling means 915, and blocking means 916. The means 914 for time measurement measures the time since the last detection of a rest state by the means 906 for the detection of the rest state. If no rest state is detected by the means 906 within a predetermined period of time, then the signalling means 915 issues signals to the user in visual, audible, or other form, in order to request him to lay the screw device down. If the user does not accord with the request, the blocking means 916 will suppress the further use of the screw device 901, if the measured time undercuts a second threshold value. The suppression of use can, as already described, be effected by the cutting of the power supply to the screw device.

With this embodiment it is ensured that the user will lay the screw device down at regular intervals. This is necessary in order for any possible defects and/or incorrect measured values to be detected. This allows for the time period for the occurrence of a defect to be restricted to the time between two checks/corrections of the angle measuring device. If a defect is detected when the screw device is laid down as requested, then, for example, the screw procedures since the last time it was laid down can be assessed as not in order, such as to guarantee safe and reliable screwing. The assessment as not in order can, for example, be carried out by sending a signal to an NOK assessment unit or to a control computer.

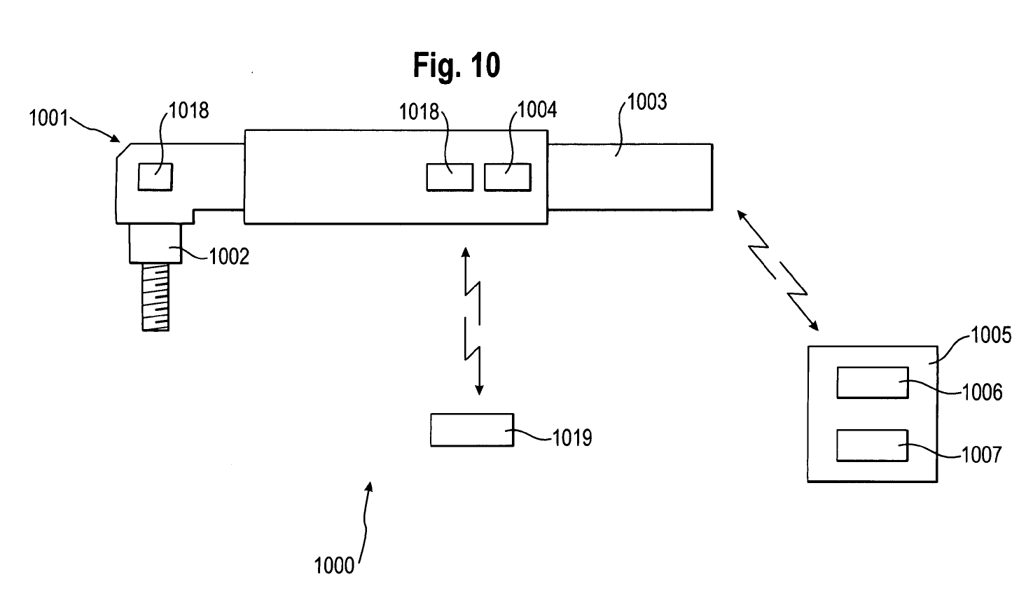

FIG. 10 shows a further embodiment of the assembly device 1000. In this situation, the first angle measuring device 1004, which is provided in the screw device 1001, measures the rotation angle of the housing about the axis of the screw head 1002 relative to the surroundings. A second angle measuring device 1018 comprises the rotation angle of the screw head 1002 relative to the housing 1003. On the basis of the outputs from the two angle measuring devices 1004 and 1018, the angle correction unit 1019 can now determine the actual rotation angle of the screw head 1002 relative to the surroundings and relative to the workpiece respectively. This makes it possible, for example with rotation angle or yield point tightening methods, for the rotation angle of the screw relative to the workpiece to be correctly determined even if the screw device 1001 is moving. In this situation, the detection unit 1005 for the detection of erroneous sensor data ensures a correct measurement of the rotation angle of the housing 1003 and allows for use even with critical screwing operations. The first angle measuring device can in this situation be formed both as a rotation rate sensor and also as a combination of acceleration sensors or other movement sensors. The second angle measuring device can, for example, be designed as an incremental or absolute rotary transducer system. The angle correction unit 1019 and the detection unit 1005 for the detection of erroneous sensor data can be arranged both in the screw device as well as outside it.

As represented in FIG. 11A, the first angle measuring device 1104 can also be designed in redundant format, with several sensors 1120 for the redundant measurement of the rotation angle of the screw device, or, as represented in FIG. 11B, can comprise an intrinsically safe sensor 1121 for the measurement of the rotation angle of the screw device.

These embodiments offer the advantage that, even during the movement of the screw device, and not only in the rest state, it is possible to monitor the outputs from the angle measuring device. This makes a further contribution to the precision and reliability of the tightening method.

The sensors of the first angle measuring device 1204 can also be designed as sensors with differing measuring methods 1120a, 1120b, as represented in FIG. 12, in order, for example, to reduce the influence of the temperature by the use of different sensor types. These can be, for example, as represented in FIG. 13, rotation rate sensors 1120_DS and/or acceleration sensors 1120_BS.

For the correction and error detection of the sensor values of the first angle measuring device 104, it is additionally possible, as represented in FIG. 14, for error detection means 1422 to be contained, for the detection of measurement errors of the sensors in the screw device. Calculation means 1423 in this situation calculate the difference value of the several different measured values of the several sensors at one point in time. In the event of the difference value which is formed exceeding a threshold value, it is to be assumed that the measurement from the first angle measuring device 104 could not have been carried out correctly. Following this, by signalling means 1424, a message can be issued to the user in audible, visual, or other form. In addition, by the blocking means 1425, the use of the screw device can be suppressed or interrupted. An assessment of the screw procedure as “Not in order (NOK)” is likewise to be carried out.

As well as difference values, it is also conceivable for another form of comparison of the measured values to be carried out, with other methods or another form of determination of the deviation.

Accordingly, detection of measurement errors is also possible outside the rest state, and safety is further enhanced.

Represented in FIG. 15 is the assembly device 1500, with measurement comparison means 1526 for the comparison of measured sensor values from the first angle measuring device with a predetermined measurement range of the sensors of the first angle measuring device. If the signal from a sensor of the first angle measuring device exceeds the measurement range of the sensor, the measurement signal can be assessed as invalid. The exceeding of the measurement range means that no exact analysis of the reliability of the screw device can be made any longer, and, as appropriate, the screw connection can be assessed as not in order and/or a signal can be issued to the user. In conjunction with the angle correction unit, this type of monitoring offers the advantage that deviation against the screw tool or a movement in sympathy by the screw tool in relation to the screwing-in device is only possible within specific geometrical and physiological limits. This allows for the measurement range of the sensor(s) with regard to precision to be optimally selected in relation to use as a sensor for the angle correction unit for screw tools and, at the same time, for an error in the measurement sensor apparatus or on the part of the user to be reliably detected. Likewise, a maximum permissible rotation angle speed and threshold value or a maximum permissible rotation angle and a threshold value respectively can be defined. If one of these is exceeded, the current screwing procedure is assessed as “Not in order (NOK)”.

In addition to this, as represented in FIGS. 16 and 17, further operating parameters can be monitored. In FIG. 16, additionally, the supply voltage is monitored by means of supply voltage monitoring means 1627. In the event of the supply voltage departing from a tolerance range, reliable function of the sensor can no longer be guaranteed, and the screwing operation can be assessed as not in order, and/or corresponding signals can be issued to the user, and/or the screw tool can be blocked.

In FIG. 17, moreover, a screw device 1701 is represented with a temperature measuring unit 1728. The temperature measuring device 1728 can be placed in the area of a sensor in order to monitor the temperature of the sensor or of the surroundings of the sensor. If the temperature detected is outside a tolerance range, correct function of the sensor cannot be guaranteed, and corresponding signals can likewise be issued or the use of the screw device blocked completely. In this situation, the monitoring can be carried out by separate temperature measuring units in different areas of the screw device 1701 or at different sensors. Other additional operating parameters which can be monitored during the operation of sensors are generally known to the person skilled in the art, and do not need to be explained in greater detail here.

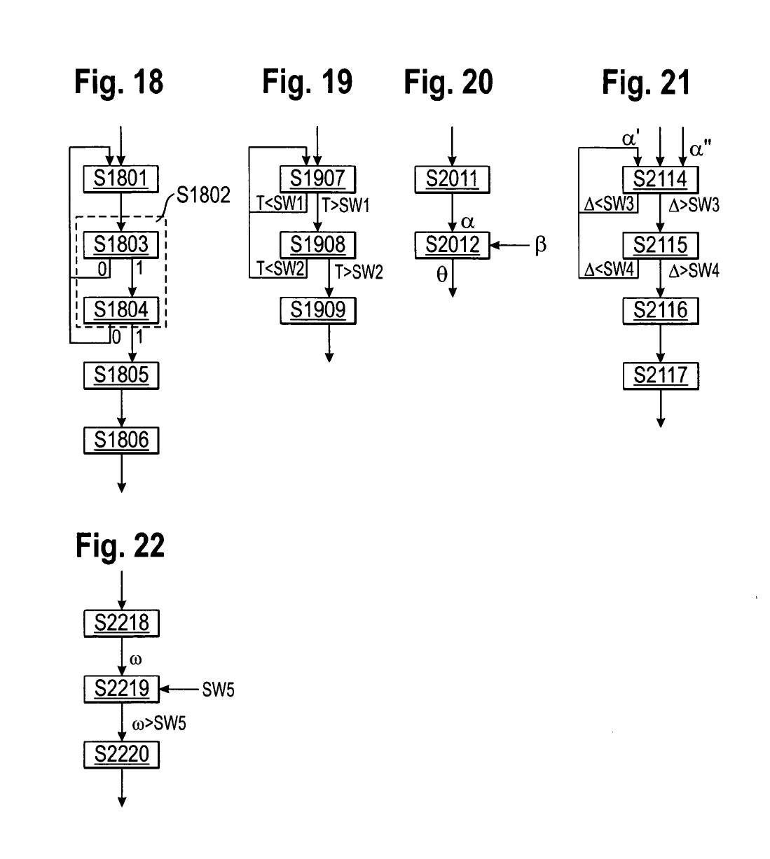

FIG. 18 shows a flow diagram of an embodiment of the method according to the invention. In this situation, in step S1801, a rotation angle of the housing about the axis of the screw head relative to the surroundings is detected by means of a first angle measuring device. The following step, of the detection S1802 of erroneous sensor data in the rest state by means of a detection device, first contains the step of detection S1803 of the rest state. If a rest state is detected, the step follows of comparison S1804 of the sensor values of the first angle determination unit with predefined threshold value or a tolerance range respectively. If it is detected in this situation that the sensor values lie outside the tolerance range or above/below a threshold value, wherein two threshold values can defined a tolerance range, then in step S1805 a message can be sent to the user by a signalling means. The suppression S1806 of the use of the screw device is also conceivable.

The detection of the rest state can in this situation be carried out by the method already described. In addition, the first angle measuring device or another sensor can be used in the screw device, inasmuch as this is checked for constant output values or constant angle signals derived from these, over a defined period of time. If, for example, the angle measuring device issues a constant or close to constant value, then it is to be assumed that the screw device is in the rest state.

FIG. 19 shows a flow diagram of a further embodiment of the method according to the invention, with steps of requesting the user to lay the screw tool down. In this situation, in step S1907 the time is measured since the screw device was last laid down. If the time T exceeds a first threshold value SW1, then step S1908 follows, in which a message is issued to the user. If a second threshold value SW2 is now exceeded, the use of the screw device is suppressed in step S1909.

FIG. 20 shows a flow diagram of a further embodiment of the method according to the invention. This comprises the step of detection S2011 of the rotation angle a of the screw head relative to the housing. Following this, with the rotation angle in step S2012, the actual rotation angle θ of the screw head relative to the surroundings is calculated from the measured rotation angle of the screw head α and the detected rotation angle of the housing β. Accordingly, the influence is minimized of the rotational movement of the screw device on the rotation angle by which, for example, further rotation takes place following a joint or threshold moment, since the actual rotation angle in relation to the workpiece or the surroundings is determined.

FIG. 21 represents, as a further embodiment, a method for the detection of a measurement error during the use of the screw device. In this situation, first at least one difference value Δ is calculated from at least two measured values α′α″ from at least two sensors in step S2114. If at least one difference value Δ exceeds a threshold value SW3, then a message is issued to the user in step S2115. If the threshold value SW4 is also exceeded, then, in step S2216, the use of the assembly device can be completely suppressed. Screwing must be interrupted as appropriate, and the screwing operation must be assessed as “Not in order (NOK)”. In this situation, either two different threshold values can be used, or even only one threshold value (SW3=SW4).

Likewise, as represented in FIG. 22, a maximum permissible rotation angle speed or a threshold value respectively are defined. A rotation angle speed determined in step S2218, which is determined by making use of the first angle measuring device, is compared with the threshold value in step S2219. If the rotation angle speed exceeds the threshold value, then the current screwing operation is assessed as “Not in order (NOK)”. The rotation angle speed can be determined in this situation by making use of the first rotation angle measuring device. In a similar way, a maximum permissible rotation angle or a threshold angle respectively can be defined. If this is exceeded, then current screwing operation is likewise assessed as “Not in order (NOK)”. This further enhances the operational safety of the system.

In addition, a current screwing operation can be assessed as “Not in order (NOK)” if an error occurs during the screwing operation. An error can in this situation be one of the situations described heretofore, such as the exceeding of a threshold value or a tolerance range. The assessment can in this situation be issued to the user as a signal and/or provided as a signal for further processing by external devices.

The screw devices of the embodiments are designed as motor-driven screw devices. In this situation, these can be, for example, screw devices powered by electricity, hydraulics, or compressed air. With electrically-driven screw tools, the power supply can be ensured either by means of a battery, referred to as EC-battery screw tools, and/or via a cable. The cable can, if appropriate, also be used for the transfer of signals to/from the external components of the assembly device.

As already described, different components of the assembly device can be arranged either directly in the screw device or externally in an additional module. Some components can also be integrated in already-existing control systems for the screw device. In this situation, the control of the components of the screw device can be put into effect, for example, as microprocessor-based, computer-controlled, or by other means known to the person skilled in the art.

Any desired combination of the features cited in the Claims is also conceivable.

The screw device is not limited to the angle screw device represented in the drawings. It is also conceivable for it to be designed as a screw device with, for example, a straight drive (bar screw device or pistol screw device).

From the foregoing description, the person skilled in the art will recognise that various modifications and variations of the assembly device and the corresponding methods can be carried, without leaving the scope of the invention.

Moreover, the invention has been described by reference to specific examples, which are, however, intended only to serve for better understanding of the invention, and it is not intended to be restricted to these. The person skilled in the art will recognise immediately that many different combinations of hardware, software, and firmware can be used to carry out the present invention, in particular for the realization of the function of the detection unit.

### INDUSTRIAL APPLICATION

The assembly device can be used, for example, in automobile construction in final assembly or in the assembly of vehicle components. Other use, for example in the mechanical engineering sector or other sectors in which screw devices are used, is likewise conceivable.

1-33. (canceled)

34. An assembly device with a motor-driven screw device for the tightening or loosening of screws, with a screw head and a housing, wherein the screw device comprises:
a first angle-measuring device for the detection of the rotation angle of the housing about the axis of the screw head relative to the surroundings;
wherein the assembly device comprises a detection unit for the detection of erroneous sensor data in a rest state, comprising:
means for detecting the rest state, and
means for comparing sensor data measured in the rest state with one or more predefined threshold values.

35. The assembly device of claim 34, wherein the detection unit further comprises:
signalling means for sending a message to the user; and
blocking means for suppressing the use of the screw device.

36. The assembly device of claim 34, wherein the means for detecting the rest state comprises at least one sensor in the screw device for the detection of movement.

37. The assembly device of claim 34, wherein the means for detecting the rest state comprises at least one sensor in the screw device, for the detection of the contact of the screw device with a surface, or the screw device coming close to a surface.

38. The assembly device of claim 34, wherein the means for detecting the rest state comprises a tool mount with at least one sensor for the detection of the laying of the screw device in the tool mount, for the detection of the rest state.

39. The assembly device of claim 34, wherein the means for detecting the rest state comprises means, in the screw device, for the detection of the position of the screw device in space.

40. The assembly device of claim 34, wherein the means for detecting the rest state comprises at least one transponder and means for reading the transponder, wherein either the transponder or the means for reading the transponder are arranged in the screw device.

41. The assembly device of claim 34, wherein the comparison means is configured to compare the sensor data with a minimum limit value and a maximum limit value.

42. The assembly device of claim 34, wherein the comparison means is configured to compare the sensor data with a tolerance range around a defined initial value.

43. The assembly device of claim 34, further comprising:
means for time measurement that measure the time since the last laying down of the screw device detected by the means for detecting the rest state;
signalling means for outputting a message to the user if the measured time exceeds a first threshold value; and
blocking means for suppressing the use of the screw device if the measured time exceeds a second threshold value.

44. The assembly device of claim 34, further comprising:
a second angle-measuring device for detecting the rotation angle of the screw head relative to the housing, located in the screw device; and
an angle correction unit configured to determine the actual rotation angle of the screw head relative to the surroundings from the measured rotation angle of the screw head and the detected rotation angle of the housing, located in the assembly device.

45. The assembly device of claim 34, wherein the first angle measuring device comprises either a plurality of sensors for the redundant measurement of the rotation angle of the screw device, or at least one intrinsically safe sensor.

46. The assembly device of claim 34, wherein the first angle measuring device comprises a plurality of sensors with different measurement methods.

47. The assembly device of claim 45, wherein the sensors of the first angle measuring device are either rotation-rate sensors or acceleration sensors.

48. The assembly device of claim 45, further comprising:
error detection means for the detection of measurement errors from the sensors, comprising:
calculation means for the calculation of at least one difference value from the several measured values from the several sensors;
signalling means for sending a message to the user, if at least one difference value exceeds a threshold value; and
blocking means for suppressing the use of the screw device.

49. The assembly device of claim 34, further comprising:
a measurement range comparison means for the comparison of measured sensor values from the first angle-measuring device with a predetermined measurement range from the sensors of the first angle-measuring device.

50. The assembly device of claim 34, further comprising:
a supply voltage monitoring means for the monitoring of the supply voltage of the sensors.

51. The assembly device of claim 34, wherein the screw device further comprises at least one temperature measuring unit located substantially adjacent to a sensor, configured to measure the temperature of the sensor.

52. The assembly device of claim 34, wherein the screw device is powered by electricity, hydraulics, or compressed air.

53. The assembly device of claim 34, wherein the screw device further comprises a battery configured to supply power to the screw device.

54. A method for the tightening or loosening of screws by means of a motor-driven screw device with a screw head and a housing, the method comprising:
detecting a rotation angle of the housing about an axis of the screw head relative to the surroundings of the housing by means of a first angle-measuring device;
wherein detecting a rotation angle comprises:
detecting erroneous sensor data in a rest state by means of a detection unit, comprising:
detecting the rest state; and
comparing, by comparison means, the sensor values measured in the rest state with predefined threshold values.

55. The method of claim 54, further comprising the steps:
sending a message to the user by signalling means; and
suppressing the use of the screw device by blocking means.

56. The method of claim 54, wherein detecting of the rest state comprises the detection of movement by means of a sensor in the screw device.

57. The method of claim 54, wherein detecting the rest state comprises detecting a constant output value from either a sensor or the angle measuring device, over a predetermined period of time.

58. The method of claim 54, wherein the step of the detection of the rest state comprises the detection of a contact of the screw device with a surface or the screw device coming close to a surface.

59. The method of claim 54, wherein detecting the rest state comprises detecting the laying of the screw device on a tool mount.

60. The method of claim 54, wherein detecting the rest state comprises determining the position of the screw device.

61. The method of claim 54, further comprising:
measuring the time since the last occasion when the screw device was laid down;
signalling a message to the user if the measured time exceeds a first threshold value; and
suppressing the use of the screw device if the measured time exceeds a second threshold value.

62. The method of claim 54, further comprising:
detecting the rotation angle of the screw head relative to the housing; and
determining the actual rotation angle of the screw head relative to the surroundings, from the measured rotation angle of the screw head and the detected rotation angle of the housing.

63. The method of claim 54, further comprising:
calculating at least one difference value of several measured values from several sensors of the first angle measuring device;
sending a message to the user, if at least one difference value exceeds a threshold value;
suppressing the use of the screw device if at least one difference value exceeds the threshold value or another predetermined threshold value.

64. The method of claim 54, further comprising the following steps:
determining a rotation angle speed of the housing about the axis of the screw head;
comparing the rotation angle speed with a threshold value;
assessing an ongoing screwing operation as being not in order (NOK) if the rotation angle speed exceeds the threshold value.

65. The method of claim 54, further comprising:
assessing an ongoing screwing operation as not in order (NOK) if the rotation angle of the housing about the axis of the screw head exceeds a threshold value.

66. The method of claim 54, further comprising:
assessing an ongoing screwing operation as not in order (NOK) if an error occurs during the screwing operation.
